(19) United States
(12) Patent Application Publication
(10) Pub. No.: US 2010/0219974 A1
(43) Pub. Date: Sep. 2, 2010

(54) SYSTEM CONTROLLING ELECTRIC POWER AND SYSTEM CONTROLLING VALVE

(76) Inventor: Keun-Jin Lee, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/594,574

(22) PCT Filed: Apr. 4, 2008
(86) PCT No.: PCT/KR08/01904

§ 371 Date: Apr. 26, 2010

(30) Foreign Application Priority Data
Apr. 4, 2007 (KR) 10-2007-0033416

(51) Int. Cl. G05B 11/01

(52) U.S. Cl. 340/825

(57) ABSTRACT

Disclosed is a system for interrupting an electric power of an outlet or closing a gas valve through detection of the absence of a user. The system includes a signal transmission device installed on an outside of the outlet and a gas valve device. The signal transmission device detects the existence of the user to output the gas valve device receive the control signal to control the flow of connected to signal an electric power or gas.

### TECHNICAL FIELD

The present invention relates to a system for interrupting an electric power of an outlet or closing a gas valve through detection of the absence of a user.

### BACKGROUND ART

Although an electronic appliance connected to an outlet is turned off, a small quantity of electric current is consumed, which is called a “standby power”. Such a standby power not only has a bad influence on the lifetime of an electric/electronic appliance, but also plays a role in power consumption. In addition, the standby power has the problem of increasing the possibility of an electric leakage.

In order to interrupt the standby power, users should fully unplug electronic appliances in a standby mode from outlets one by one, which is a laborious task. In addition, in the case where the electronic appliances are not unplugged due to user's carelessness, it is not possible to interrupt the standby power. Consequently, a system is required for interrupting the standby power, if a user is absent, by detecting the absence using a sensor, in order to solve the above problems.

Valves of gas pipelines have the same necessity as described above. More specifically, in the case where the valve of a combustible gas pipeline is not closed when a user is absent, the risk of a fire caused by gas leakage is highly increased. In this instance, a system for closing the gas valve automatically by detecting a user's absence is also required.

However, in the case where a system for automatically interrupting the standby power or closing the gas valve is installed in all outlets and gas valves, the number of sensors is increased to incur expenses, which leads in an inefficient drawback.

### DISCLOSURE OF INVENTION

### Technical Problem

Therefore, it is required for a system composed of a device for detecting a user's absence, and a device for interrupting the standby power and closing the gas valve in the user's absence.

### Technical Solution

Therefore, the present invention has been made in view of the above-mentioned problems, and the present invention provides an apparatus for interrupting a standby power so as to effectively manage the standby power.

That is, an object of the present invention is to provide a system for controlling an outlet power which can reduce the consumption of a standby power by detecting the existence of a user who is in a specific area and connecting an outlet with an electric power, and if the user is not in the area, interrupting power supply to the outlet.

In particular, object of the present invention is to provide a system for controlling outlet power, in which a signal transmission device for detecting the existence of a user through a sensor and transmitting a power control signal to an outlet is adapted to move separately from the outlet, so that a user can place the signal transmission device at a wanted position.

Still another object of the present invention is to provide an apparatus for closing a pipeline valve to effectively manage a gas valve or the like.

That is, object of the present invention is to provide a pipeline valve control system which can detect the existence of a user who exists in a specific area, and close a pipeline valve according to the detected result.

In particular, still another object of the present invention is to provide a pipeline valve control system, in which a signal transmission device for detecting the existence of a user through a sensor and transmitting a pipeline valve control signal to a device for controlling the pipeline valve is adapted to move separately from the outlet, so that a user can place the signal transmission device at a wanted position.

In accordance with an aspect of the present invention, there is provided a power control system including a signal transmission device and a power supply device, the signal transmission device including an object detecting sensor for detecting the existence of an object and a signal transmitting unit for transmitting a control signal in response to detection of the object detecting sensor, and the power supply device including a signal receiving unit for receiving the control signal and a power control unit for controlling flow of an electric power according to the received control signal. The signal transmission device is installed on an outside of the power supply device, and the signal transmitting unit of the signal transmission device is connected to the signal receiving unit of the power supply device by wire or wirelessly.

Preferably, the power supply device is an outlet.

Preferably, the signal transmission device is connectable with a plurality of power supply devices by wire or wirelessly, and the signal transmitting unit of the signal transmission device can transmit a control signal to all power supply devices connected thereto.

Also, preferably, the power control unit turns on the power supply, if the signal receiving unit is disconnected from the signal transmitting unit.
*The signal transmission device further includes a timer, and the signal transmitting unit transmits a control signal to turn off the power supply, if the object is not detected over a first predetermined standby time, and transmits a control signal to turn on the power supply if the object is detected over a second predetermined standby time.

In accordance with another aspect of the present invention, there is provided a valve control system including a signal transmission device and a valve device, the signal transmission device including an object detecting sensor for detecting the existence of an object and a signal transmitting unit for transmitting a control signal in response to the detection of the object detecting sensor, and the valve device including a signal receiving unit for receiving the control signal and a valve control unit for controlling flow of a fluid according to the received control signal. The signal transmission device is installed on an outside of the valve supply device, and the signal transmitting unit of the signal transmission device is connected to the signal receiving unit of the valve device by wire or wirelessly.

In accordance with still another aspect of the present invention, there is provided an integrated power/valve control system including a signal transmission device, a power supply device, and a valve device, the signal transmission device including an object detecting sensor for detecting existence of an object and a signal transmitting unit for transmitting a control signal in response to detection of the object detecting sensor, the power supply device including a power control signal receiving unit for receiving the control signal and a power control unit for controlling flow of an electric power according to the received control signal, and the valve device including a valve control signal receiving unit for receiving the control signal and a valve control unit for controlling flow of a fluid according to the received control signal. The signal transmission device is installed on the outside of both the power supply device and the valve device, and the signal transmitting unit of the signal transmission device is connected to the power control signal receiving unit of the power supply device and the valve control signal receiving unit of the valve device by wire or wirelessly.

### ADVANTAGEOUS EFFECTS

With the above-described construction, the present invention can properly interrupt a standby power of an outlet when a user is absent, thereby preventing consumption of power and fire risk. Also, the present invention can properly close a pipeline valve, thereby preventing gas poisoning, fire risk and waste of gas or city water.

Since a signal transmitting unit having a pyroelectric sensor and a timer is easily connected to or disconnected from a signal receiving unit of an outlet, and the signal transmitting unit is adapted to be compatible with a plurality of outlet devices and a plurality of pipeline valve devices, it is not necessary to install an expensive signal transmission device in every application one by one, which is economical in expense.

In addition, a user can selectively control an outlet or a pipeline valve, if necessary, and wanted outlets and pipeline valves can be collectively controlled at a time.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a power control system according to the present invention;

FIG. 2 is a flowchart describing a method of controlling a power control system according to an embodiment of the present invention;

FIG. 3 is a flowchart explaining a method of controlling a power control system according to an alternative embodiment of the present invention;

FIGS. 4 and 5 show an outlet device according to an embodiment of the present invention;

FIG. 6 is a perspective view illustrating two types of a signal transmission device according to an embodiment of the present invention;

FIG. 7 is a view schematically illustrating the construction of a power control system according to an embodiment of the present invention;

FIG. 8 is a block diagram of a valve control system according to an alternative embodiment of the present invention; and

FIG. 9 is a block diagram illustrating an integrated power/valve control system according to an alternative embodiment of the present invention.

### BEST MODE FOR CARRYING OUT THE INVENTION

Hereinafter, exemplary embodiments of the present invention will be described with reference to the accompanying drawings.

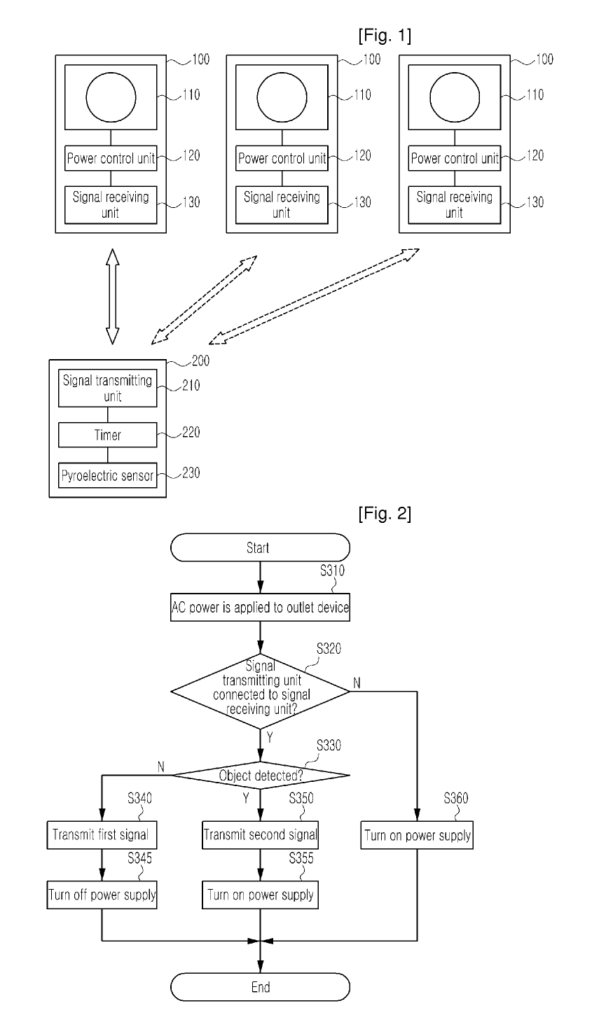

FIG. 1 is a block diagram illustrating an outlet power control system according to an embodiment of the present invention. The outlet power control system mainly includes an outlet device 100 and a signal transmission device 200.

The outlet device 100 includes an outlet unit 110, a power control unit 120, and a signal receiving unit 130. The signal transmission device 200 includes a signal transmitting unit 210, a timer 220 and a pyroelectric sensor 230.

One outlet device 100 may be connected to one signal transmission device 200, but several outlet devices 100 may be connected to one signal transmission device 200, as shown in FIG. 1. In this instance, the signal transmission device 200 and the outlet device 100 may be connected to each other by wire or wirelessly.

The outlet unit 110 receives a plug of an external electronic appliance, through which electric power is supplied to the electronic appliance.

The power control unit 120 serves to turn the supply of electric power on and off in response to a control signal which will be described hereinafter.

The signal receiving unit 130 receives the signal generated by the signal transmitting unit 210 of the signal transmission device 200.

The signal transmitting unit 210 generates and transmits the control signal according to the results detected by the pyroelectric sensor 230.

The timer 220 calculates time information required when the signal transmitting unit 210 generates the control signal.

The pyroelectric sensor 230 detects whether a human body exists around the signal transmission device 200. The pyroelectric sensor includes an infrared sensor for detecting a temperature of a human body and a ultrasonic sensor using ultrasonic wave.

The pyroelectric sensor 230 is only one example of an object detecting sensor, and any sensor capable of detecting variations of other object, as well as a human body, can be employed. That is, it can cope with various situations by detecting circumference variations (variations of objects), in addition to adjacent persons. The method of controlling the power control system will now be described with reference to FIG. 2.

FIG. 2 is a flowchart describing a method of controlling the power control system according to an embodiment of the present invention.

First, AC power is applied to the outlet device 100 (S310). Since the outlet device 100 is generally installed in a wall, the outlet device 100 is always applied with the AC power.

It is determined whether the signal transmitting unit 210 is connected to the signal receiving unit 130 (S320).

If the signal transmitting unit 210 is connected to the signal receiving unit (5320-Y), the pyroelectric sensor 230 searches whether a human body exists around the signal transmission device (S330).

If the human body is not detected (S330-N), the signal transmitting unit 210 generates and transmits a first signal to the signal receiving unit 130 (S340).

The signal receiving unit 130 of all outlet devices 100 connected thereto receives the transmitted signal. If the received signal is the first signal, the power control unit 120 turns the power supply off (S345). As a result, since the applied AC power does not flow in the outlet unit 110, it looks as if the plug of the electronic appliance is disconnected from the outlet unit 110, thereby preventing generation of standby power.

Otherwise, if a human body is detected (5330-Y), the signal transmitting unit 210 generates and transmits a second signal (S350).

The signal receiving unit 130 of all outlet devices 100 connected thereto receives the transmitted signal. If the received signal is the second signal, the power control unit 120 turns the power supply on (S355). The expression “turning on” means that the applied AC power flows out of the outlet unit 110. That is, if the plug of the electronic appliance is connected to the outlet unit 110, the electronic appliance can be supplied with the electric power from the outlet.

The method of controlling the power of the outlet device 100 may employ a relay, but the present invention is not limited thereto.

In this embodiment, the outlet device 100 and the signal transmission device are adapted to be easily connected to each other or disconnected from each other.

FIG. 4 shows the outlet device according to an embodiment of the present invention, in which the outlet device is provided on a front surface thereof with an input socket 131 of a 4-port plug type for the signal receiving unit. The connection/disconnection of the signal transmitting unit 210 is conveniently performed by using 4-port plugs of female/male type. The present invention is not limited to the 4-port plug, and other types of cable connection or wireless network may be used for the connection.

The cable connection has an intuitive advantage. In the wireless connection, a plurality of outlet devices 100 can be easily connected to one signal transmission device 200 by unifying protocols therebetween.

As described above, the signal transmission device 200 of the present invention is easily connected to and disconnected from the outlet device. If the power control system includes a plurality of outlet devices 100, the signal transmission device 200 may be connected to any one of the outlet devices 100. The plurality of outlet devices are identical standards, and the first signal and the second signal can be transmitted to all outlet devices. Since the respective signals are identical to each other, some outlet devices 100 can be controlled by only one signal transmission device 200.

In the case where a specific outlet device is not used or an outlet device is not necessary to interrupt the standby power, it is not required to connect the signal transmission device with the outlet device. In this instance, the signal transmission device may be disconnected from the outlet device, and the outlet device to be disconnected from the signal transmission device can operate in the same manner as a conventional outlet device.

Referring again to FIG. 2, in the case where the signal transmitting unit 210 is not connected with the signal receiving unit 130 (S320-N), that is, the outlet device 100 is disconnected from the signal transmission device 200, the power control unit 120 turns the power supply on (S360). More specifically, the electric current continuously flows in the outlet device 100, irrespective of the results detected by the pyroelectric sensor. When the plug of the electronic appliance is inserted in the outlet device, the electric power is supplied to the electronic appliance. Consequently, the outlet device 100 can be used as an existing outlet device.

In the case of the disconnection, the input signal will be a non-input signal (zero voltage). If the second signal is defined as a non-input signal (zero voltage), the power control unit 120 can be manufactured using a simple algorithm.

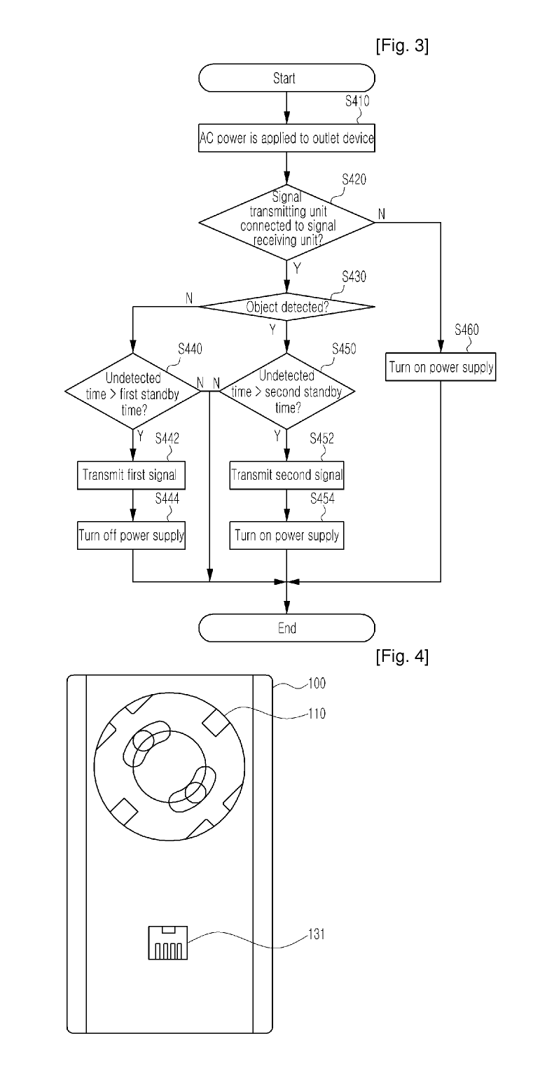

FIG. 3 is a flowchart explaining a method of controlling the power control system connected to a timer according to an alternative embodiment of the present invention.

In FIG. 3, steps S410, S420 and S460 are similar to steps S310, S320 and S360 in FIG. 2, and thus the description thereof will be omitted herein.

If the object is not detected in step S430 (S430-N) and the object is not detected over a first standby time (S440-Y), the first signal is transmitted (S442) to turn the power supply off (S444). That is, if the power supply is turned off whenever a user leaves his/her seat for a moment, it may cause the user inconvenience.

In addition, if the object is detected in step S430 (S430-Y) and the object is detected over a second standby time (S450-Y), the second signal is transmitted (S452) to turn the power supply on (S454).

By setting the standby time, it can reduce the inconvenience unexpected by the user. In addition, in the case of setting the standby time, it can better detect a human body. In the case where the first standby time related to generate the first signal meaning that the user is absent is longer than the second standby time, it can operate a system securing the stability.

Any timer will be allowed in the present invention as long as it generates time information. Since the timer is implemented by those skilled in the art, its detailed description will be omitted herein.

A predetermined time may be used as the first and second standby times, and a user may input the predetermined time through external input means, such as a dial or button, as shown in FIG. 6.

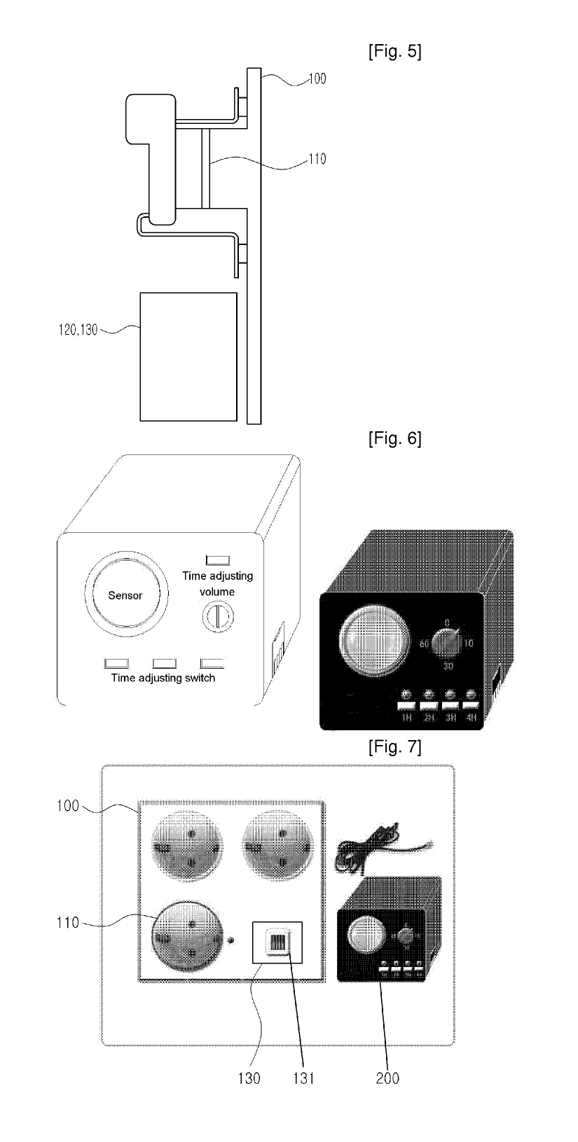

FIGS. 4 and 5 show the outlet device according to an embodiment of the present invention. The outlet device shown in FIG. 4 includes an outlet unit 110. An input socket 131 installed in the signal receiving unit 130 is shown as a 4-port type socket in this embodiment. FIG. 5 shows a cross-sectional view of the outlet device 100 shown in FIG. 4. The outlet device 100 in FIG. 4 includes an outlet unit 110, a signal receiving unit and power control units 120 and 130.

FIG. 7 is a view schematically illustrating the construction of the power control system according to an embodiment of the present invention, in which a signal transmission device 200 and a signal receiving unit 130 are connected by wire through an input socket 131 for the signal receiving unit.

The present invention may be applied to a pipeline valve, as well as the power control of the outlet. Comparing the pipeline valve control system with the power control system for the outlet, the power control unit is replaced by a valve control unit 520 which is not interrupting the power of the outlet, but operates the pipe valve unit 510 to interrupt the flow of a fluid in the pipeline.

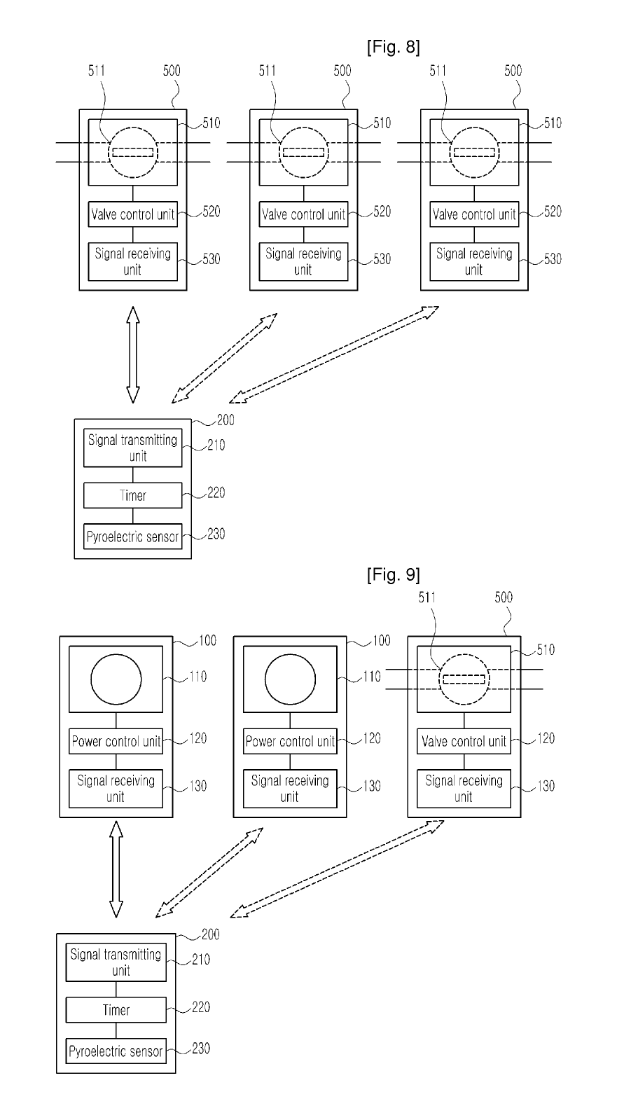

FIG. 8 is a block diagram of a valve control system according to an alternative embodiment of the present invention.

The valve control system includes a valve device 300 having a pipeline valve unit 510, a valve control unit 520 and a signal receiving unit 530, and a signal transmission device 200 having a timer 220 and a pyroelectric sensor 230.

The signal receiving unit 530 receives any one of a first signal and a second signal to send it to the valve control unit 520. If the valve control unit 520 receives the first signal, the valve control unit 520 interrupts the valve of the pipeline valve unit 510. If the valve control unit 520 receives the second signal, the valve control unit 520 opens the valve of the pipeline valve unit 510.

Like the power control system for the outlet, the signal transmitting unit and the signal receiving unit are adapted to easily connect to and disconnect from each other. In one embodiment, the connection and the disconnection may be conveniently performed by using 4-port plugs of a female/male type.

Since the connection/disconnection of the signal transmission device is conveniently performed, the signal transmission device may be connected to any one of a plurality of pipeline valve devices. In addition, the plurality of pipeline valve devices have the same standards, and the control signal including the first and second signals may be transmitted to the plurality of pipeline valve devices. Since the respective signals are the same, and thus are compatible, some pipeline valve devices can be controlled by using one signal transmission device.

In the case where a specific pipeline valve device is not used or a pipeline valve device is not necessary to interrupt the gas in a user's absence, it is not required to connect the signal transmission device with the pipeline valve device. In this instance, the pipeline valve device to be disconnected from the signal transmission device can operate in the same manner as a conventional pipeline valve device. More specifically, in the case where the signal receiving unit is disconnected from the signal transmitting unit, it is preferable to set a manual mode in which a user turns the valve directly with his or her hand. It is preferably that the second signal indicating that a person is nearby is set as a non-input signal (zero voltage).

The method of controlling the pipeline valve unit employs a relay or a motor or gears so as to open or close the valve.

In the case of an LPG or LNG pipeline valve which is used in the present invention, the valve control unit is preferably designed to disregard the second signal which is an open signal, at an initial stage. Consequently, the valve can be closed in user's absence, but it is able to prevent the valve from being opened due to malfunction caused by, for example, pet animals. The above-described effect can be obtained by installing a filter not in the valve control unit but in the signal receiving unit, so that the second signal is interrupted not to be transmitted to the valve control unit. In this instance, a switch is installed in the filter, so that the user can select the operation of the filter.

The present invention may be applied to pipelines for various fluids, for example, a faucet, as well as the combustible gas pipeline.

By integrating the outlet power control system and the pipeline valve control system, an integrated outlet power/pipeline valve control system can be achieved to control all outlet devices and pipeline valve devices by using only one signal transmission device.

FIG. 9 shows an integrated power/valve control system according to an alternative embodiment of the present invention.

FIG. 9 is a block diagram of the integrated power/valve control system according to the present invention. The integrated power/valve control system includes an outlet device 100 having an outlet unit 110, a power control unit 120, and a signal receiving unit 130, a signal transmission device 200 having a signal transmitting unit 210, a timer 220 and a pyroelectric sensor 230, and a valve device 300 having a pipeline valve unit 310, a valve control unit 320 and a signal receiving unit 330.

The signal receiving unit and the power control unit of the outlet device 100, and the signal receiving unit and the valve control unit of the pipeline valve device 300 are connected to the same signal transmission device 200. More specifically, the signal transmission device 200 is adapted to be compatible for the outlet device 100 and the valve device 500. Consequently, the outlet device 100 and the valve device 500 can be selectively or simultaneously controlled by using one signal transmission device 200.

Although the outlet device 100 is described as the power supply device in this embodiment, it is merely one example for clarity. Therefore, any device adapted to supply an electric power to an electronic appliance may be employed, for example, a plug connected to an electronic appliance and receiving a signal to interrupt the electric power.

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A power control system having a signal transmission device and a power supply device;
wherein the signal transmission device comprises:
an object detecting sensor for detecting existence of an object, and
a signal transmitting unit for transmitting a control signal in response to detection of the object detecting sensor; and
the power supply device comprises:
a signal receiving unit for receiving the control signal, and
a power control unit for controlling flow of an electric power according to the received control signal;
wherein the signal transmission device is installed on an outside of the power supply device, and the signal transmitting unit of the signal transmission device is connectable to the signal receiving unit of the power supply device by wire or wirelessly.

2. The power control system as claimed in claim 1, wherein the power supply device is an outlet.

3. The power control system as claimed in claim 1, wherein the signal transmission device is connectable with a plurality of power supply devices by wire or wirelessly, and the signal transmitting unit of the signal transmission device can transmit a control signal to all power supply devices connected thereto.

4. The power control system as claimed in claim 1, wherein the power control unit turns on the power supply if the signal receiving unit is disconnected from the signal transmitting unit.

5. The power control system as claimed in claim 1, wherein the signal transmission device further comprises a timer, and the signal transmitting unit transmits a control signal to turn off the power supply, if the object is not detected over a first predetermined standby time, and transmits a control signal to turn on the power supply if the object is detected over a second predetermined standby time.

6. A valve control system having a signal transmission device and a valve device; wherein the signal transmission device comprises:
an object detecting sensor for detecting existence of an object, and
a signal transmitting unit for transmitting a control signal in response to detection of the object detecting sensor; and
the valve device comprises:
a signal receiving unit for receiving the control signal, and
a valve control unit for controlling flow of a fluid according to the received control signal;
wherein the signal transmission device is installed on an outside of the valve supply device, and the signal transmitting unit of the signal transmission device is connected to the signal receiving unit of the valve device by wire or wirelessly.

7. The control system as claimed in claim 6, wherein the signal transmission device is connectable with a plurality of valve devices by wire or wirelessly, and the signal transmitting unit of the signal transmission device can transmit a control signal to all valve supply devices connected thereto.

8. The valve control system as claimed in claim 6, wherein the valve device is adapted to only manually control fluid supply if the signal receiving unit is disconnected from the signal transmitting unit.

9. The valve control system as claimed in claim 6, wherein the signal transmission device further comprises a timer, and the signal transmitting unit transmits a control signal to turn off the fluid supply if the object is not detected over a first predetermined standby time, and transmits a control signal to turn on the fluid supply if the object is detected over a second predetermined standby time.

10. An integrated power/valve control system having a signal transmission device, a power supply device, and a valve device;
wherein the signal transmission device comprises:
an object detecting sensor for detecting existence of an object, and
a signal transmitting unit for transmitting a control signal in response to detection of the object detecting sensor;
the power supply device comprises:
a power control signal receiving unit for receiving the control signal, and
a power control unit for controlling flow of an electric power according to the received control signal; and
the valve device comprises:
a valve control signal receiving unit for receiving the control signal, and
a valve control unit for controlling flow of a fluid according to the received control signal;
wherein the signal transmission device is installed on outsides of the power supply device and the valve device, and the signal transmitting unit of the signal transmission device is connectable to the power control signal receiving unit of the power supply device and the valve control signal receiving unit of the valve device by wire or wirelessly.

11. The integrated power/valve control system as claimed in claim 10, wherein the signal transmitting unit is connectable with a plurality of power control signal receiving units and valve control signal receiving units by wire or wirelessly, and the signal transmitting unit can transmit a control signal to all power control signal receiving units connected thereto and valve control signal receiving units connected thereto.

12. The integrated power/valve control system as claimed in claim 10, wherein the power control unit turns on power supply if the power control signal receiving unit is disconnected from the signal transmitting unit, and the valve control unit is adapted to only manually control fluid supply if the signal receiving unit is disconnected from the signal transmitting unit.
